(19) United States
(12) Patent Application Publication
(10) Pub. No.: US 2015/0147256 A1
(43) Pub. Date: May 28, 2015

(54) PROCESS FOR THE COUPLED PREPARATION OF POLYSILAZANES AND TRISILYLAMINE

(71) Applicants: Carl-Friedrich Hoppe, Gruendau (DE); Christian Götz, Seligenstadt (DE); Hartwig Rauleder, Rheinfelden (DE); Goswin Uehlenbruck, Oberursel (DE)

(72) Inventors: Carl-Friedrich Hoppe, Gruendau (DE); Christian Götz, Seligenstadt (DE); Hartwig Rauleder, Rheinfelden (DE); Goswin Uehlenbruck, Oberursel (DE)

(73) Assignee: Evonik Industries AG, Essen (DE)

(21) Appl. No.: 14/344,801

(22) PCT Filed: Jun. 25, 2013
(86) PCT No.: PCT/EP2013/063286

§ 371 Date: Mar. 13, 2014

(30) Foreign Application Priority Data
Aug. 10, 2012 (DE) 10 2012 214 290.8

(51) Int. Cl. C01B 21/087; B01J 19/24

(52) U.S. Cl. CPC C01B 21/087; B01J 19/24; B01J 2219/24
USPC 423/324; 422/187

(57) ABSTRACT

The invention relates to a process for preparing trisilylamine and polysilazanes in the liquid phase, in which ammonia dissolved in an inert solvent is initially introduced in a substoichiometric amount relative to monochlorosilane which is likewise present in an inert solvent. The reaction is carried out in a reactor in which trisilylamine formed according to the following equation

4NH₃+3H₃SiCl→3NH₄Cl+(SiH₃)₃N

and polysilazanes are formed. The reactor is subsequently depressurized and TSA is separated off in gaseous form from the product mixture. The TSA obtained is purified by filtration and distillation and obtained in high or very high purity. Further ammonia dissolved in an inert solvent is subsequently introduced into the reactor, using, together with the previously introduced amount of ammonia, a stoichiometric excess of ammonia relative to the amount of MCS previously present. Excess ammonia is subsequently discharged, inert gas is introduced and the bottom product mixture from the reactor is passed through a filter unit, with solid ammonium chloride being separated off and a liquid mixture of polysilazanes and solvent being obtained.

The present invention relates to a process for preparing trisilylamine and polysilazanes in the liquid phase, in which ammonia dissolved in an inert solvent is initially introduced in a substoichiometric amount relative to monochlorosilane which is likewise present in an inert solvent. The reaction is carried out in a reactor in which polysilazanes are formed in addition to trisilylamine. The reactor is subsequently depressurized and TSA is separated off in gaseous form from the product mixture. The TSA obtained is purified by filtration and distillation and obtained in high or very high purity. Further ammonia dissolved in an inert solvent is subsequently introduced into the reactor, using, together with the previously introduced amount of ammonia, a stoichiometric excess of ammonia relative to the amount of MCS previously present. Excess ammonia is subsequently discharged, inert gas is introduced and the bottom product mixture from the reactor is passed through a filter unit, with solid ammonium chloride being separated off and a liquid mixture of polysilazanes and solvent being obtained.

Polysilazanes are polymers having a basic structure composed of silicon and nitrogen atoms in an alternating sequence. An overview may be found, for example, in http://de.wikipedia.org/wiki/Polysilazane or in M. Weinmann, “Polysilazanes” in “Inorganic Polymers”, edited by R. De Jaeger and M. Gleria, pp. 371-413.

In polysilazanes, each silicon atom is usually bound to two nitrogen atoms, or each nitrogen atom is bound to two silicon atoms, so that these can be described predominantly as molecular chains of the formula [R₁R₂Si—NR₃]ₙ. The radicals R₁, R₂ and R₃ can be hydrogen atoms or organic radicals. When only hydrogen atoms are present as substituents, the polymers are referred to as perhydropolysilazanes [H₂Si—NH]ₙ. If hydrocarbon radicals are bound to silicon and/or nitrogen, the compounds are referred to as organopolysilazanes.

Polysilazanes are colourless to yellowish liquids or solids, predominantly from oily through wax-like to glassy, with a density of about 1 kg/l. The average molar mass can be from a few hundred to above 100 000 g/mol. Both molar mass and molecular macrostructure determine the state of matter and the viscosity. At a molar mass above 10 000 g/mol, the melting point is 90-140° C. High molecular weight perhydropolysilazane [(SiH₂)NH]ₓ is a white substance resembling silicic acid. Polysilazanes age slowly with elimination of H₂ and/or NH_{3.}

Relatively small molecules can be converted into larger molecules by thermal treatment. At temperatures of from 100 to 300° C., crosslinking of the molecules takes place with elimination of hydrogen and ammonia.

Polysilazanes are used as coating material and as constituent of high-temperature surface coatings of corrosion protection systems. Since they are additionally good insulators, they are used in the electronics and solar industry. In the ceramics industry, they are used as preceramic polymers. Furthermore, polysilazanes are employed for high-performance coating of steel to protect against oxidation. They are marketed as 20% strength by weight solution.

Polysilazanes can be prepared from chlorosilanes or hydrocarbon-substituted chlorosilanes and ammonia or hydrocarbon-substituted amines (apart from ammonia and amines, hydrazine can likewise be used in the reaction). The reaction forms ammonium chloride or hydrocarbon-substituted amine chlorides, which have to be separated off, in addition to the polysilazanes. The reactions are essentially spontaneous, exothermic reactions.

The preparation of polysilazanes by reaction of monochlorosilane, dichlorosilane or trichlorosilane with ammonia in each case is known in the prior art, with use of monohalosilanes, dihalosilanes or trihalosilanes being possible. Perhydropolysilazanes are formed here. When hydrocarbon-substituted starting materials are used, the formation of organopolysilazanes is expected. The high molecular weight polysilazanes obtained in these syntheses using dichlorosilanes and trichlorosilanes have a low solubility and can therefore be separated off from the ammonium chloride which is formed at the same time only with difficulty.

If ammonia is reacted with dichlorosilane, relatively high molecular weight polysilazanes are formed directly, as disclosed in the documents CN 102173398, JP 61072607, JP 61072614, JP 10046108, US 4397828, WO 91/19688. x in the following reaction equation is at least 7.

3NH₃+H₂SiCl₂→2NH₄Cl+[SiH₂(NH)]ₓ (1)

In the reaction of ammonia with trichlorosilane, three-dimensional structures of polysilazanes are formed directly according to the following reaction equation.

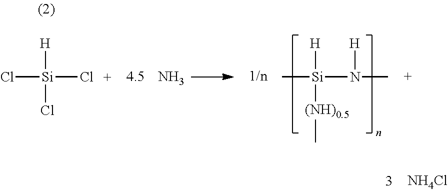

The abovementioned synthetic routes can be carried out using a solvent. A further possibility is to introduce halosilane into liquid ammonia, as provided for in the patent application WO 2004/035475. This can aid the separation of the ammonium halide from the polysilazanes since the ammonium halide is soluble in ammonia while the polysilazanes form a second liquid phase. The liquids can be separated from one another by phase separation.

Apart from the preparation using halosilanes in a solvent and in liquid ammonia, there are further processes without additional formation of salts. These include catalytic dehydro coupling, redistribution reactions, ring-opening polymerizations, which are described in another reference (M. Weinmann, Polysilazanes, in Inorganic Polymers, Editors: R. De Jaeger, M. Gleria, pp. 371-413). These methods are not used industrially in order to prepare polysilazanes.

There is great interest in a commercial preparation of trisilylamine, N(SiH₃)₃. This is not formed in the abovementioned reaction routes. Rather, it is formed from the reaction of monochlorosilane and ammonia according to equation (3):

4NH₃₊3H₃SiCl→3NH₄Cl+(SiH₃)₃N (3)

The substance, which is abbreviated here and in the following as “TSA”, is a mobile, colourless and readily hydrolysable liquid having a melting point of −105.6° C. and a boiling point of +52° C. Like other nitrogen-containing silicon compounds, TSA is an important substance in the semiconductor industry.

The use of TSA for the production of silicon nitride layers has been known for a long time and is described, for example, in the documents U.S. Pat. No. 4,200,666 and JP 1986-96741. TSA is used in particular in chip production as layer precursor for silicon nitride or silicon oxynitride layers. A specific process for the use of TSA is disclosed by the patent application published as WO 2004/030071, in which it is made clear that when used in chip production, reliable, malfunction-free production of TSA in constant high purity is particularly important.

An article in J. Am. Chem. Soc. 88, 37 ff., 1966, describes the reaction of gaseous monochlorosilane with ammonia to form TSA on the laboratory scale with slow addition of ammonia, with polysilazanes and ammonium chloride being simultaneously formed. The simultaneous production of TSA and polysilazanes is therefore known in principle. However, industrial production of both substances has hitherto foundered on a series of problems. Thus, ammonium chloride is obtained in solid form and blocks the feed lines of the starting materials. TSA and polysilazanes can neither be separated nor produced in the purities required for the markets in which they are of interest. In addition, it has hitherto not been possible to adjust the ratio of TSA to the polysilazanes which are obtained in addition. On top of everything, ammonia catalyzes vigorous decomposition of TSA as soon as TSA in the liquid phase and ammonia are present above a certain critical amount. Thus, preparation of TSA and polysilazanes in one and the same process above the laboratory scale has hitherto not been possible.

It was therefore an object of the invention to provide a commercially interesting process which synthesizes both products simultaneously, in adjustable amounts, and with complete circumvention of the disadvantages and limitations of the prior art.

This object has unexpectedly been solved by ammonia dissolved in an inert solvent firstly being introduced in a substoichiometric amount relative to monochlorosilane which is likewise present in an inert solvent. The reaction is carried out in a reactor in which polysilazanes are formed in addition to trisilylamine according to equation (3).

The reactor is subsequently depressurized and TSA is separated off in gaseous form from the product mixture. The TSA obtained is purified by low-temperature filtration and distillation and is obtained in high or very high purity. Further ammonia dissolved in an inert solvent is subsequently introduced into the reactor, with, together with the previously introduced amount of ammonia, a stoichiometric excess of ammonia relative to the amount of MCS previously present being used. Excess ammonia is subsequently discharged, inert gas is introduced and the bottom product mixture from the reactor is conveyed cold through a filter unit, with solid ammonium chloride being separated off and a liquid mixture of polysilazanes and solvent being obtained.

The invention accordingly provides a process for preparing trisilylamine and polysilazanes in the liquid phase, wherein
(a) monochlorosilane (MCS) dissolved in a solvent (L) is placed in liquid form in a reactor (1) , where the solvent is inert towards monochlorosilane, ammonia, TSA and polysilazanes and has a boiling point higher than that of TSA, and
(b) the reaction is carried out in reactor (1) by introducing ammonia (NH₃) in a substoichiometric amount relative to monochlorosilane (MCS) and dissolved in the solvent (L) into the reactor (1) and
(c) the reactor (1) is subsequently depressurized, where
   (c1) the product mixture (TSA, L, NH₄Cl) is taken off in gaseous form from the top of the reactor (1) and passed through a distillation unit (2) and collected in a vessel (6), subsequently
   (c2) filtered at low temperature by means of filter unit (3), with solid ammonium chloride (NH₄Cl) being separated off from the product mixture, and the filtrate is conveyed from the filter unit (3) into the distillation column (4) in which TSA is separated off from the solvent (L) at the top and
   (c3) ammonia (NH₃) dissolved in the solvent (L) is introduced into the reactor (1), using, together with the amount of ammonia (NH₃) introduced in step (b), a stoichiometric excess of ammonia relative to the amount of MCS initially charged in step (a), and
   (c4) excess ammonia (NH₃) is discharged from the reactor and inert gas is introduced into the reactor (1) and
   (c5) the bottom product mixture (PS, L, NH₄Cl) from the reactor (1) is passed cold through a filter unit (5), with solid ammonium chloride (NH₄Cl) being separated off,
and a mixture of polysilazanes (PS) and solvent (L) is obtained.

In step (c), the reactor is depressurized in a manner known to those skilled in the art by opening a valve above the liquid present in the reactor.

For the purposes of the present invention, low-temperature filtration is a filtration in the temperature range from −60 to 0° C. Cold filtration is a filtration in the temperature range from −20 to 10° C.

The process of the invention is explained in more detail below.

For the purposes of the invention, the introduction of ammonia in step (b) is also referred to as first introduction. The amount of the ammonia (NH₃) introduced in the solvent (L) into the reactor (1) provided in the first introduction is preferably selected so as to be from 2 to 5 mol % below the stoichiometric amount. This avoids catalytic decomposition of TSA by ammonia, which proceeds very vigorously. The product mixture obtained in the reaction in the reactor (1) during step (b) contains ammonium chloride (NH₄Cl).

The inert solvent (L) used in the process of the invention is preferably selected so that ammonium halides, particularly preferably ammonium chloride, are insoluble therein. This aids both the removal of the ammonium halide in step (c1) and also the carrying out of the process in the production of perhydropolysilazanes.

Preference is given to using an inert solvent which forms neither an azeotrope with TSA nor with the polysilazanes obtained while carrying out the process of the invention. The inert solvent should preferably be less volatile than TSA. Such preferred solvents can be selected from among pyridine, tetrahydrofuran, diethylene glycol dimethyl ether, triethylene glycol dimethyl ether, tetraethylene glycol dimethyl ether, toluene, xylene and dibutyl ether.

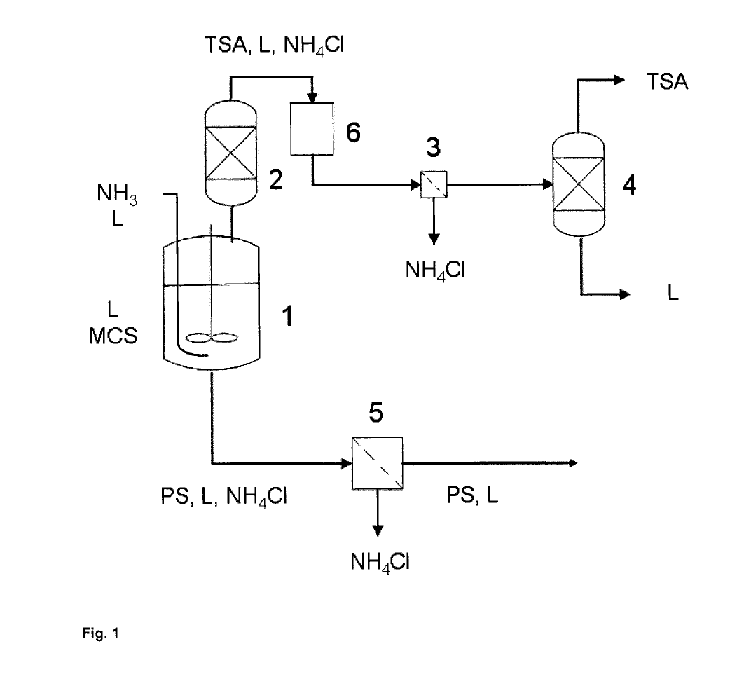

Very particular preference is given to using toluene as solvent (L). If monochlorosilane dissolved in toluene is placed in liquid form in the reactor and ammonia dissolved in toluene is introduced into the reactor as shown in FIG. 1, preferably with mixing or stirring, then monochlorosilane and ammonia are prevented from reacting with one another in the feed line for ammonia and blockage of the feed line by precipitation of ammonium chloride is prevented.

Furthermore, TSA is stable in toluene. In addition, ammonium chloride is sparingly soluble in toluene, which aids the removal of ammonium chloride by means of filtration. This has already been described in the earlier patent application DE 10 2011 088814.4, whose disclosure content is hereby expressly incorporated into the scope of the present invention.

Polysilazanes, too, are stable in toluene.

Furthermore, toluene serves to dilute the reactor solution and to take up the enthalpy of reaction.

It can be advantageous to use the solvent (L), preferably toluene, in a volume excess over monochlorosilane (MCS) in the process of the invention. Preference is given to setting a volume ratio of the liquid solvent to monochlorosilane of from 30:1 to 1:1, preferably from 20:1 to 3:1, particularly preferably from 10:1 to 3:1. However, at volume ratios in the range from 3:1 to 1:1, the advantages become smaller. This excess ensures high dilution of monochlorosilane and this in turn increases the yield of TSA. A further advantage of using L in a volume excess over monochlorosilane (MCS) is that the concentration of ammonium chloride in the reaction solution is reduced and the stirring and emptying of the reactor is therefore made easier. However, excessively large excesses, e.g. above 30:1, have an adverse effect on the space-time yield in the reactor.

To carry out the reaction, the reactor is preferably filled to up to 99%, more preferably from 5 to 95%, particularly preferably from 20 to 80%, of the reactor volume with reaction mixture of the starting materials and the solvent.

The reaction of the reaction mixture in the reactor is advantageously carried out at a temperature of from −60 to +40° C., preferably from −20 to +10° C., particularly preferably from −15 to +5° C., very particularly preferably from −10 to 0° C. The reaction can be carried out at a pressure of from 0.5 to 15 bar, in particular at the pressure which is established under the prescribed reaction conditions. The polysilazanes (PS) obtained are chlorine-containing to a small extent. However, the predominant proportion of polysilazanes is chlorine-free. They are thus perhydropolysilazanes.

The reaction is preferably carried out under protective gas, for example nitrogen and/or a noble gas, preferably argon, and in the absence of oxygen and water, especially in the absence of moisture, with the plant present preferably being dried and flushed with protective gas before the first filling operation.

Furthermore, the vapour/liquid equilibrium pressure of a corresponding mixture of monochlorosilanes, the trisilylamine formed and to a small extent the polysilazanes in the solvent is essentially established during the reaction in the reactor as a result of the initial introduction of liquid monochlorosilane dissolved in the solvent. Ammonia does not have any effect on the vapour/liquid equilibrium pressure as long as ammonia reacts fully with the monochlorosilane present when it is introduced.

After the reaction, step (c), the reactor is depressurized.

In the process of the invention, the distillate obtained according to step (c2) can preferably be filtered at low temperature by means of filter unit (3), with solid ammonium chloride (NH₄Cl) being separated off from the distillate, and this filtrate from the filter unit (3) is introduced into the distillation column (4) in which TSA is separated off from the solvent (L) at the top. The advantage is that TSA is obtained in a purity of 99.9% by weight in this way. The step is very particularly preferably carried out by means of a further filter unit and distillation unit, but this is not shown in FIG. 1.

The polysilazanes present in the reactor (1) can contain chlorine. To convert these polysilazanes still present in the reactor into completely chlorine-free polysilazanes, preferably perhydropolysilazanes, further ammonia dissolved in L is introduced in step (c3) in order to allow chlorine which is to a small extent still bound to the polysilazanes to react fully. This introduction is, for the purposes of the invention, also referred to as second introduction. The preferred stoichiometric excess of ammonia used relative to the original amount of MCS used is in the range from 5 to 20 mol %.

After the second introduction, perhydrosilazanes which preferably have a molar mass of from 100 to 300 g/mol are obtained. The product mixture obtained according to the invention can also comprise novel perhydropolysilazanes for which there are not yet any CAS numbers. Illustrative structural formulae are shown in Table 1.

The introduction of inert gas in step (c4) flushes excess NH₃ from the reactor volume. A preferred inert gas is argon.

In step (c5), the bottom product mixture, which still contains perhydropolysilazanes having a molar mass of up to 300 g/mol, toluene and ammonium chloride, from the reactor (1) is conveyed cold through a filter unit (5), with solid ammonium chloride being separated off from the product mixture. The advantage in relation to the use of MCS in step (a) is that the filtration to separate off ammonium chloride from the perhydropolysilazanes having a molar mass of up to 300 g/mol is readily possible. Filtration to separate off ammonium chloride from polysilazanes having significantly higher molar masses would not be effected completely, but is also superfluous in the process of the invention since polysilazanes having molar masses significantly higher than 300 g/mol are only formed when dichlorosilane and/or trichlorosilane have been initially charged instead of or in addition to MCS in step (a).

As a further embodiment of the process of the invention, the solvent can subsequently be evaporated by distillation from the mixture of polysilazanes and solvent in order to increase the proportion of polysilazanes in the mixture. The concentrated solution can subsequently be taken up again in any solvent, for example dibutyl ether, and a concentration which is matched to commercial requirements can be set in this way. For example, a 2% strength by weight solution can be concentrated to 10% by weight and subsequently diluted again to 5% by weight by means of dibutyl ether. This embodiment of the process of the invention allows the solvent to be changed and/or mixtures of polysilazanes and a plurality of, at least two, solvents to be provided. The concentration of the polysilazanes obtained according to the invention can likewise be set in a targeted way, for example after an imprecise distillation.

The process of the invention can be carried out batchwise or continuously. If the process is carried out continuously, recirculation possibilities known to those skilled in the art for components can advantageously be utilized.

The invention likewise provides a plant for the reaction of at least the starting materials monochlorosilane (MCS) in a solvent (L) and ammonia in the liquid phase to form a product mixture containing trisilylamine and polysilazanes, which comprises
a reactor (1) having feed lines for the components ammonia, monochlorosilane and solvent (L) and an outlet for product mixture (TSA, L, NH₄Cl) which opens into a
   distillation unit (2) downstream of the reactor (1) and a vessel (6) which is equipped with a line to
   a filter unit (3) which has at least one solids outlet for NH₄Cl and a further line for transfer of the filtrate which opens into
   a distillation column (4) which is equipped with an outlet at the top for TSA and a discharge facility for solvent (L) from the bottom
and a discharge facility from the bottom of the reactor for the bottom product mixture (PS, L, NH₄Cl) which opens into
   a downstream filter unit (5) which has at least one solids outlet for NH₄Cl and a further line for transfer of the filtrate consisting of polysilazanes and solvent.

The plant according to the invention provides TSA and polysilazanes in high purity. If the distillate obtained according to step (c2) is to be repeatedly filtered at low temperature by means of the filter unit and repeatedly distilled by means of the distillation column in the process of the invention, the plant of the invention can be equipped with a further filter unit and a further distillation unit which can be connected downstream of the distillation column (4).

The plant of the invention is shown schematically in FIG. 1. The reference numerals have the following meanings

1 Reactor

2 Distillation unit

3 Filter unit

4 Distillation column

5 Filter unit

6 Vessel

The parts of the plant according to the invention which come into contact with the materials used according to the invention are preferably made of stainless steel and can be heated or cooled in a regulated manner.

### EXAMPLE 1

2800 ml of toluene and subsequently 432 g of monochlorosilane were introduced into a 5 l stirring autoclave which was flushed with inert gas and provided with cooling and heating. The solution was cooled to −15° C. 140 g of ammonia in a toluene feed stream of 180 ml/h was metered into the solution over a period of 6 hours. During the introduction, the temperature rose to −7° C. The pressure rose from 2 bar to 2.5 bar during the introduction.

The reactor was subsequently depressurized via a valve, a pressure of 0.5 bar was set and the stirring autoclave was heated to 86° C. 133 g of TSA containing proportions of toluene and small amounts of ammonium chloride were distilled off by means of an attached distillation unit. Filtration and subsequent distillation initially gave a TSA which was subsequently filtered and distilled again by means of the same apparatuses (3) and (4), giving TSA having a purity of 99.9% by weight.

30 g of ammonia in a toluene feed stream of 180 ml/h were subsequently metered into the reactor over a period of one hour. Temperature and pressure remain constant during the introduction. Excess ammonia was subsequently discharged from the reactor and inert gas was introduced into the reactor.

The solution of polysilazanes, toluene and ammonium chloride present in the stirring autoclave was discharged and filtered. GC-MS analysis with subsequent structure elucidation indicated perhydropolysilazanes whose structural formulae are shown in Table 1.

### EXAMPLE 2

1000 ml of toluene and subsequently 228 g of monochlorosilane were introduced into a 5 l stirring autoclave which was flushed with inert gas and provided with cooling and heating. The solution was cooled to −14° C. 74 g of ammonia in a toluene feed stream of 180 ml/h was metered into the solution over a period of 3 hours. During the introduction, the temperature rose to 2° C. The pressure dropped from 2.3 bar to 1.9 bar during the introduction.

After depressurization of the reactor, a pressure of 0.5 bar was set and the stirring autoclave was heated to 88° C. 76 g of TSA containing proportions of toluene and small amounts of ammonium chloride were distilled off by means of an attached distillation unit. Filtration and subsequent distillation initially gave a TSA which was subsequently filtered and distilled again by means of (3) and (4), giving a TSA having a purity of 99.9 by weight.

16 g of ammonia in a toluene feed stream of 180 ml/h were subsequently metered into the reactor over a period of 0.5 hour. Temperature and pressure remain constant during the introduction. Excess ammonia was subsequently discharged from the reactor and inert gas was introduced into the reactor.

The solution of polysilazanes, toluene and ammonium chloride present in the stirring autoclave was discharged and filtered. GC-MS analysis with subsequent structure elucidation indicated perhydropolysilazanes whose structural formulae are shown in Table 1.

TABLE 1

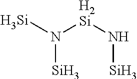

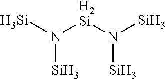

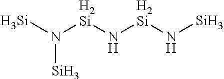

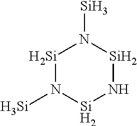

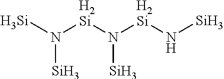

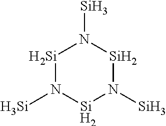

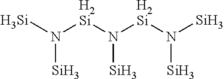

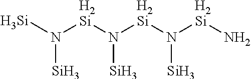

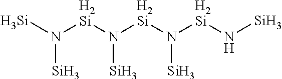

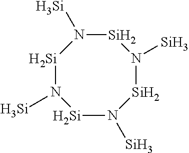

1. Process for preparing trisilylamine and polysilazanes in the liquid phase,
wherein
(a) monochlorosilane (MCS) dissolved in a solvent (L) is placed in liquid form in a reactor (1), where the solvent is inert towards monochlorosilane, ammonia, TSA and polysilazanes and has a boiling point higher than that of TSA, and
(b) the reaction is carried out in reactor (1) by introducing ammonia (NH₃) in a substoichiometric amount relative to monochlorosilane (MCS) and dissolved in the solvent (L) into the reactor (1) and
(c) the reactor (1) is subsequently depressurized, where
(c1) the product mixture (TSA, L, NH₄Cl) is taken off in gaseous form from the top of the reactor (1) and passed through a distillation unit (2) and collected in a vessel (6), subsequently
(c2) filtered at low temperature by means of filter unit (3), with solid ammonium chloride (NH₄Cl) being separated off from the product mixture, and the filtrate is conveyed from the filter unit (3) into the distillation column (4) in which TSA is separated off from the solvent (L) at the top and
(c3) ammonia (NH3) dissolved in the solvent (L) is introduced into the reactor (1), using, together with the amount of ammonia (NH₃) introduced in step (b), a stoichiometric excess of ammonia relative to the amount of MCS initially charged in step (a), and
(c4) excess ammonia (NH₃) is discharged from the reactor and inert gas is introduced into the reactor (1) and
(c5) the bottom product mixture (PS, L, NH₄Cl) from the reactor (1) is passed cold through a filter unit (5), with solid ammonium chloride (NH₄Cl) being separated off, and a mixture of polysilazanes (PS) and solvent (L) is obtained.

2. Process according to claim 1,
wherein the amount of the ammonia (NH₃) introduced in the solvent (L) into the reactor (1) in step (b) is from 2 to 5 mol % below the stoichiometric amount.

3. Process according to claim 1, wherein toluene is used as solvent (L).

4. Process according to claim 1, wherein the solvent (L) is used in a volume excess over monochlorosilane (MCS).

5. Process according to claim 1, characterized in that the reaction in reactor (1) is carried out at a temperature of from −60 to +40° C.

6. Process according to claim 1, wherein
the distillate obtained according to step (c2) is filtered at low temperature by means of filter unit (3), with solid ammonium chloride (NH₄Cl) being separated off from the distillate, and this filtrate is conveyed from the filter unit (3) into the distillation column (4) in which TSA is separated off from the solvent (L) at the top.

7. Process according to claim 1, wherein a stoichiometric excess of ammonia of from 5 to 20 mol % is used in step (c3).

8. Plant for the reaction of at least the starting materials monochlorosilane (MCS) in a solvent (L) and ammonia in the liquid phase to form a product mixture containing trisilylamine and polysilazanes, which comprises
a reactor (1) having feed lines for the components ammonia, (MCS) and (L) and
an outlet for product mixture (TSA, L, NH₄Cl) which opens into a
distillation unit (2) downstream of the reactor (1) and a vessel (6) which is equipped with a line to
a filter unit (3) which has at least one solids outlet for NH₄Cl and
a further line for transfer of the filtrate which opens into a distillation column (4) which is equipped with an outlet at the top for TSA and a discharge facility for solvent (L) from the bottom,
and a discharge facility from the bottom of the reactor for the bottom product mixture (PS, L, NH₄Cl) which opens into
a downstream filter unit (5) which has at least one solids outlet for NH₄Cl and a further line for transfer of the filtrate consisting of polysilazanes and solvent.
